(19) United States
(12) Patent Application Publication
(10) Pub. No.: US 2024/0335769 A1
(43) Pub. Date: Oct. 10, 2024

(54) DENSITY-BASED SEPARATOR

(71) Applicant: COOL SEPARATIONS B.V., Poortugaal (NL)

(72) Inventors: Jaap VAN SPRONSEN, Noordwijk (NL); Jordy OTTEN, Poortugaal (NL)

(21) Appl. No.: 18/573,660

(22) PCT Filed: Jun. 30, 2022
(86) PCT No.: PCT/NL2022/050376

§ 371 Date: Dec. 22, 2023

(30) Foreign Application Priority Data
Jun. 30, 2021 (NL) 2028588

(51) Int. Cl. B01D 21/00

(52) U.S. Cl. CPC B01D 21/0042; B01D 21/0045; B01D 21/0084

(57) ABSTRACT

The invention is in the field of separators, in particular the invention is directed to a density-based separator for separating a first and a second component comprised in a feed fluid, wherein said first component has a lower density than said fluid and said second component has a higher density than said fluid. The separator comprises a output section and a separation chamber. The invention is further related to a method for separating two components comprised in a feed fluid. The separator may be particularly suitable for water purification systems.

The invention is directed to a density-based separator and method for separating two components comprised in a feed fluid. The invention is further directed to such a separator and method for a salt and ice.

Gravity separation may be considered a general term for the separation of components based on their density. Many large industries such as the oil and the water purification industry use separation techniques based on gravity. Gravity separation may be particularly suitable for streams comprising solids suspended or dispersed in a liquid. The solid particles typically fall through a liquid and deposit by sedimentation on, for instance, a surface. The process of falling through the liquid may also be referred to as settling.

Roughly two gravity separators may be distinguished, being clarifiers and thickeners. Whether it is called a clarifier or a thickener depends on the desired product stream. If it is desired to remove solids from a liquid and obtain the purified liquid, the system is considered a clarifier. If the solid particles are desired, than it is typically a thickener.

In water purification systems clarifiers are typically used to purify i.a. waste water and sewage. Herein water to be purified is fed into the clarifier where removal of the solid pollutants occurs by permitting the solids to settle to the bottom of the clarifier. However, typically flocculation reagents need to be added to the water before it is led into the clarifier to allow for the solid particles to agglomerate that can settle more quickly and stably.

A method to increase the settling capacity of a clarifier is to insert a stack of tubes (i.e. a tube settler) or plates (i.e. a lamella clarifier). Lamella clarifiers work by having a series of inclined plates that provide a large effective settling area for the solid particles. The solid particles contact the plates and sink to the bottom of the clarifier, where the solids can be removed.

An example of a tube-settler is disclosed in U.S. Pat. No. 3,615,025, where an apparatus for removing entrained solids from liquids is described that includes a container with an inlet at a low position and an outlet at a high position wherein two vertically spaced layers of inclined channels are positioned.

Another example can be found in U.S. Pat. No. 3,903,000, which describes a settler wherein water is discharged after separation of particle solid substances and liquid at its upper part, while particle solid substances are discharged from the bottom of the settler.

U.S. Pat. No. 10,918,974 discloses an apparatus for the separation of solid particles from a fluid stream based on changing the direction of the fluid stream within a lumen of an enclosed vessel to allow for the solid particles to fall by gravity to the bottom portion.

However, while these systems may work for only rising or only descending particles (dependent on their relative density compared to the fluid), these systems are not suitable for the individual separation of two components comprised in a fluid. These systems are particularly not suitable for simultaneously and individually separating two components comprised in a fluid wherein a first component has a lower density than the fluid and a second component has a higher density than the fluid.

Examples of fluid comprising two components that require separation include aqueous salt/ice mixtures obtained from eutectic freeze crystallizers as for instance described in WO2013/051935. Conventionally, these mixtures are separated in vessels, allowing the ice to float on top of the vessel and allowing the salt to sink to the bottom (see for example Reddy et al. Investigating factors that affect separation in a eutectic freeze crystallisation process, Abstracts of the International Mine Water Conference (2009), p. 649-655). Alternatively, column separators can be used as described in Van der Tempel, Eutectic Freeze Crystallization: Separation of Salt and Ice, Master Thesis (June 2012), TU Delft, p. 13).

A drawback associated with these conventional systems is the limited purity of the ice and salt crystals after separation. In the aforementioned publication by Reddy et al. this problem is recognized and attempted to be solved by considering agitation rates and settling/flotation times in the separation vessel. However, a relatively low purity is still observed. Further, higher settling/flotation times reduce the throughput. In addition, the separation vessel only enables batchwise separation and no continuous operation.

It is therefore an object of the present invention to provide another and preferably improved density-based separator that allows for the at least partial separation of a first component and a second component comprised in a feed fluid, wherein said first component has a lower density than said fluid and said second component has a higher density than said fluid, which does not or less suffer from the above-mentioned drawbacks.

The present inventors surprisingly found that the entrapment of one component in another components in the conventional system is caused by a too rapid rising and concentration of the less dense component. The present inventors realized that a point to consider is the interaction between the first and second component. The settling second component hinders the first component in their rise upwards by blocking their path and by creating a downward force on the first component when they are hit by the second component and vice versa. The present inventors realized that in order to minimize this effect, the distance between the first and second component should be as large as possible and the settling distance in the separator should be as short as possible. The shorter the settling distance, the smaller the number of collisions between the first and second component and the faster the separation.

The present inventors further realized that a further point to consider is the interaction between the first component particles. At a certain slurry density, the first component forms a loose agglomerate in solution between which the second component can be trapped. At the critical slurry density the second component becomes entrapped in the first component.

The present inventors further realized that yet a further point to consider is the relative velocity of the first component and second component in the liquid upon separation. For example, in water, ice crystals have a much higher upwards velocity than the salt crystals' downwards velocity.

The present inventors surprisingly found that the above-mentioned object of the invention can be achieved by considering these points.

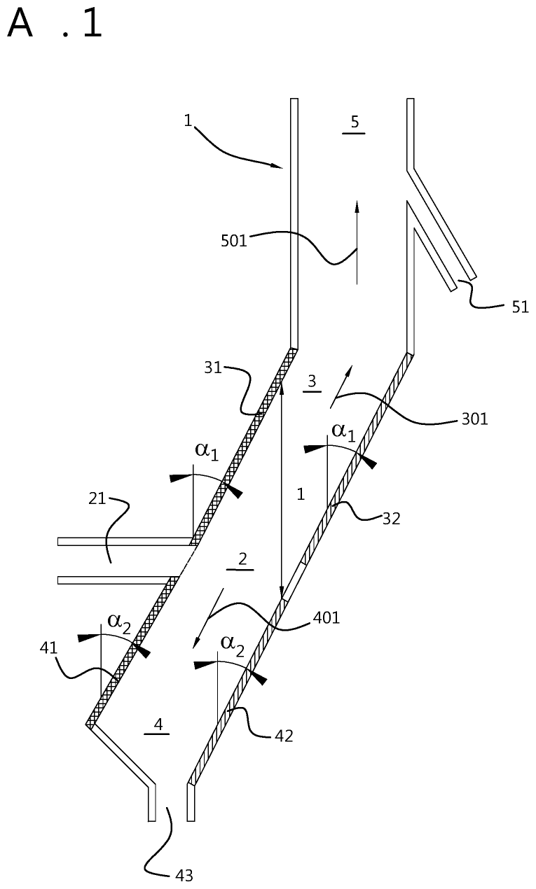

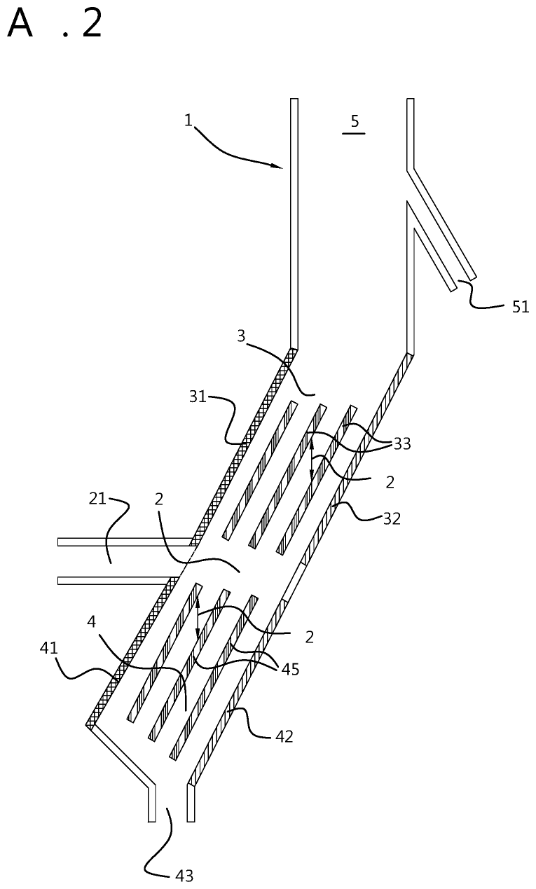

FIG. 1 illustrates a cross-sectional view of a preferred embodiment of the density-based separator according to the present invention.

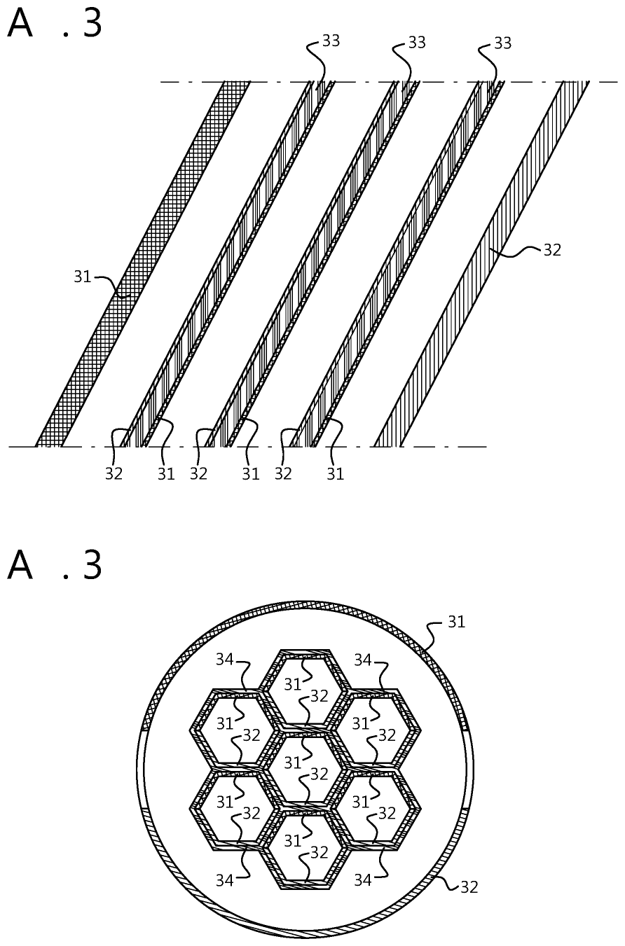

FIG. 2 illustrates a cross-sectional view of a preferred embodiment of the density-based separator according to the present invention comprising lamella.

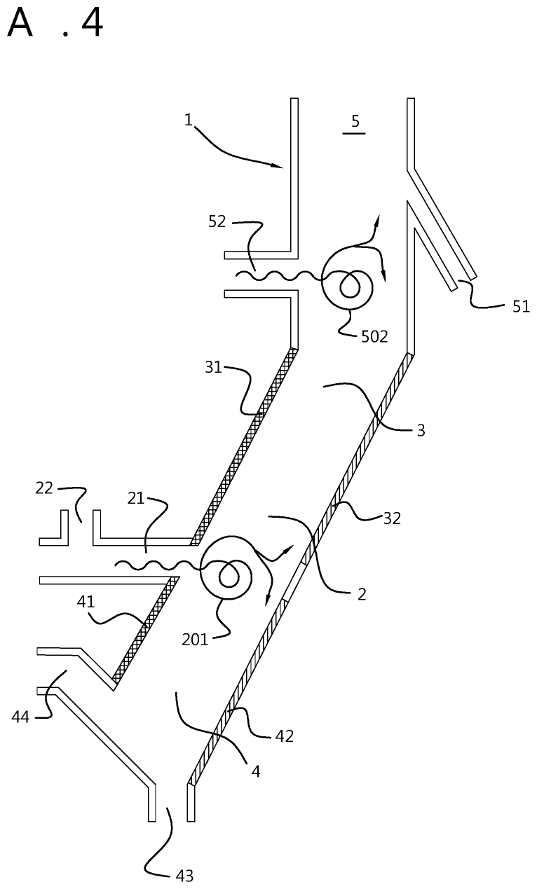

FIGS. 3A-B illustrate two cross-section views of suitable lamella from a side-view and a cross-sectional view of suitable tubes in the top section.

FIG. 4 illustrates a cross-sectional view of a preferred embodiment of the density-based separator according to the present invention wherein top and middle turbulent flows are shown.

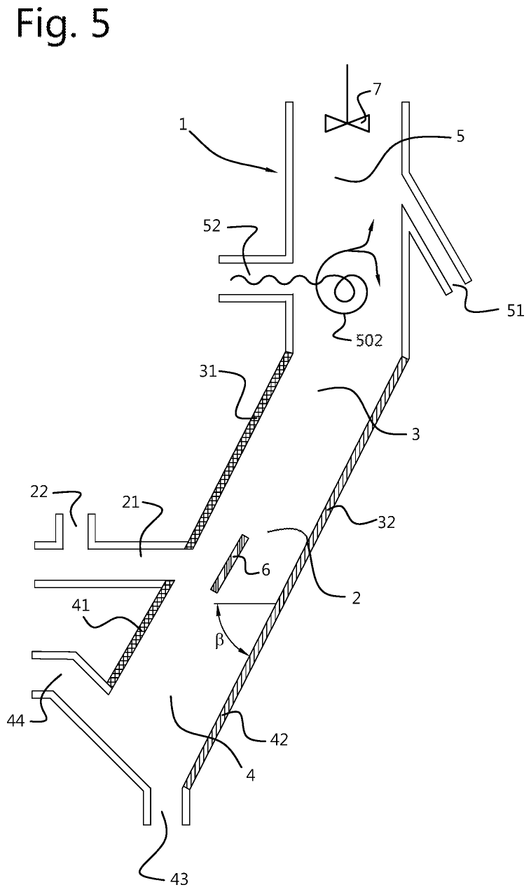

FIG. 5 illustrates a cross-sectional view of a preferred embodiment of the density-based separator according to the present invention wherein the top inclined descend surface and the bottom incline descend surface are directly connected and wherein a fluid actuator device and a flow disturbance minimizer are illustrated.

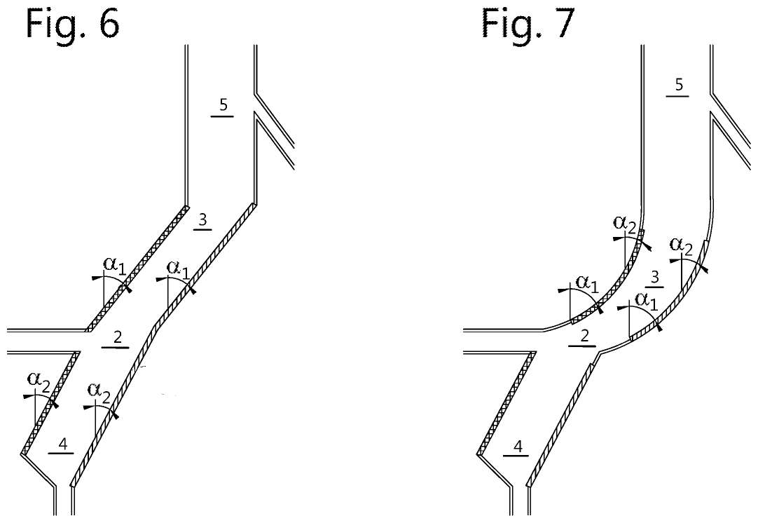

FIG. 6 illustrates a cross-sectional view of an alternative embodiment wherein angle α1 is larger than α2.

FIG. 7 illustrates a cross-sectional view of an alternative embodiment wherein α1 varies over a particular range.

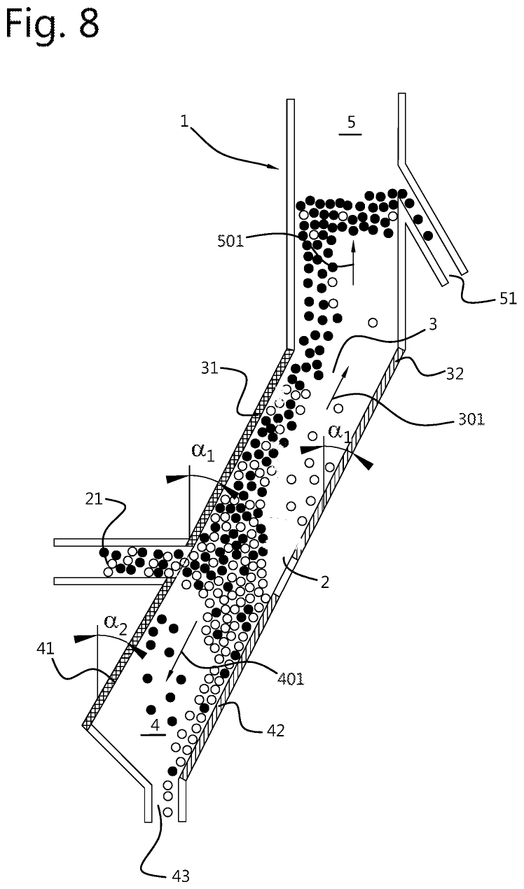

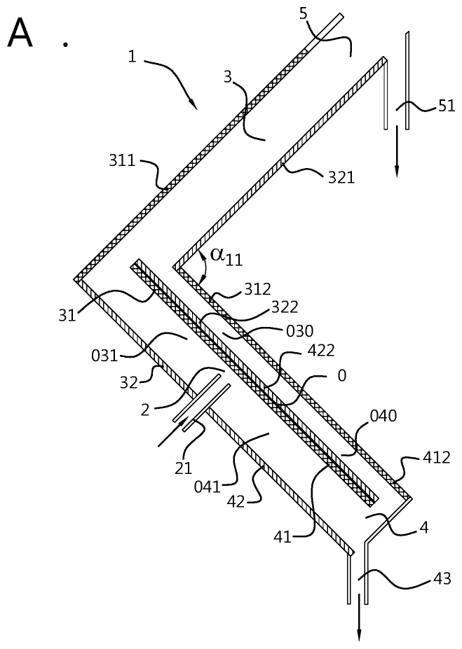

FIG. 8 schematically shows a cross-sectional view of the separation of the first and second component in the density-based separator according to the present invention.

FIG. 9 illustrates a cross-sectional view of a preferred embodiment comprising a first section divider.

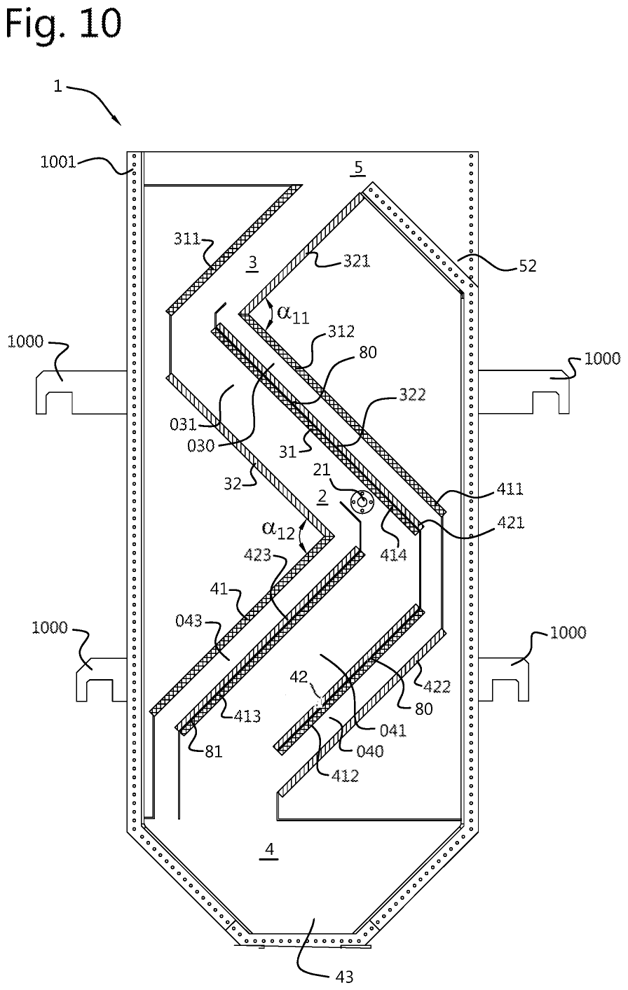

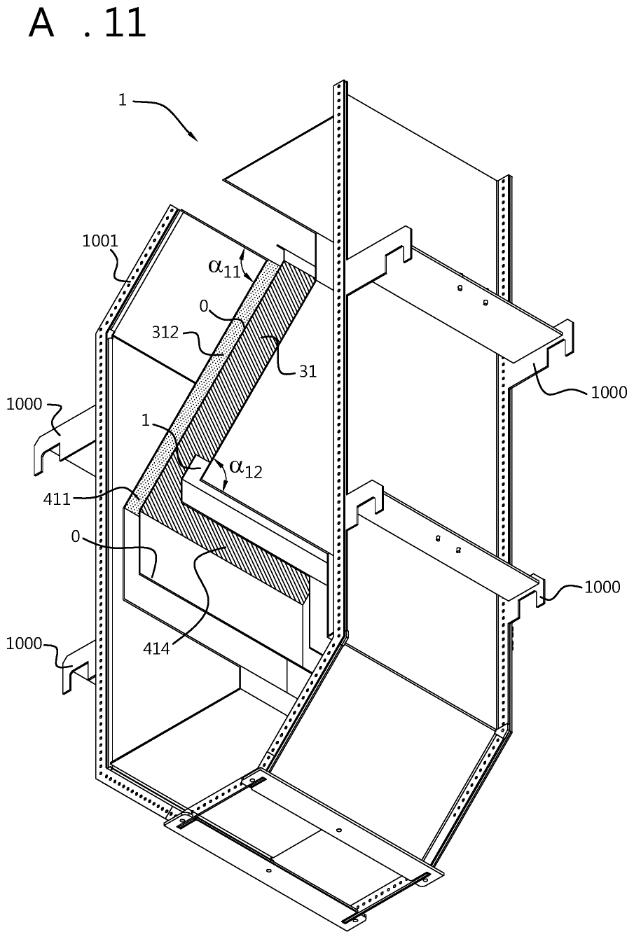

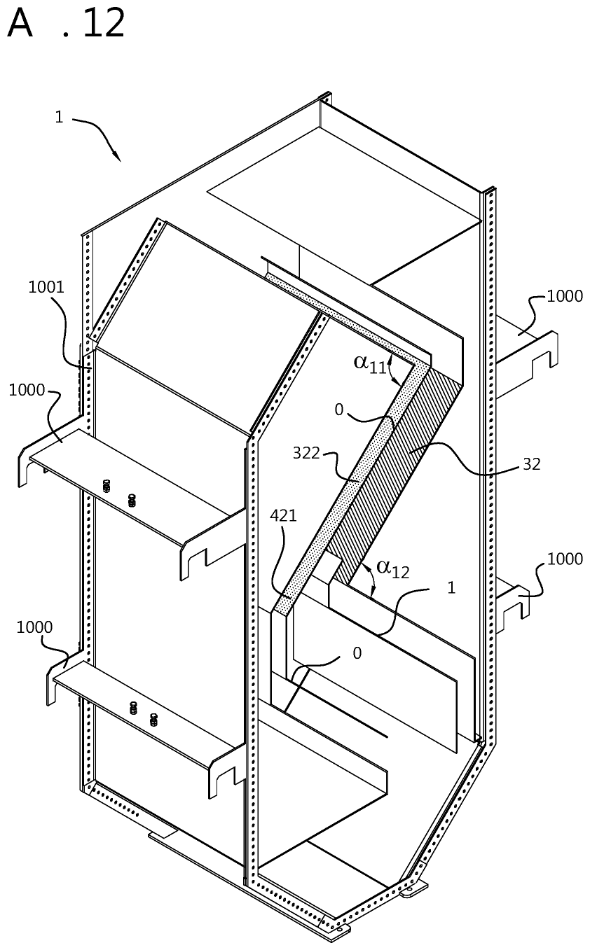

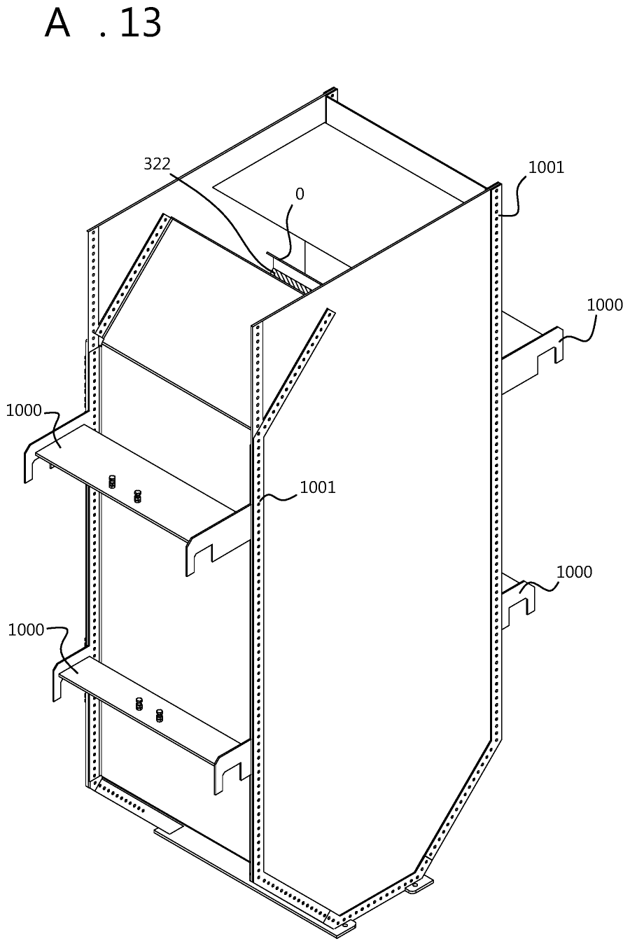

FIG. 10 illustrates a cross-sectional view of preferred embodiment comprising a first and second section divider from several perspectives. FIGS. 11-14 provide additional illustrations at different angles of this embodiment.

In a first aspect, as illustrated in FIG. 1, the present invention is directed to a density-based separator (1) for at least partially separating a first and a second component comprised in a feed fluid, wherein said first component has a lower density than said fluid and said second component has a higher density than said fluid, wherein said separator comprises a output section (5) and a separation chamber that comprises a top section (3), a middle section (2) and a bottom section (4) which are all in fluid connection with each other, wherein during use of the separator said top section (3) is located above the middle section (2) and said bottom section (4) is below said middle section; wherein
said middle section (2) comprises a feed fluid inlet (21);
said top section (3) comprises a top inclined rise surface (31) that is adapted to during use of the separator guide a rising stream that is enriched in the first component to the output section and a top inclined descend surface (32) that is adapted to during use of the separator guide a descending stream that is enriched in the second component to the middle and/or bottom section and which surfaces are both inclined and in between which during use of the separator a counter-gravitational laminar flow path (301) can be provided;
said bottom section (4) comprises a bottom inclined rise surface (41) that is adapted to during use of the separator guide a rising stream that is enriched in the first component to the top section and a bottom inclined descend surface (42) that is adapted to during use of the separator guide a descending stream that is enriched in the second which surfaces are both inclined and in between which during use a gravitational laminar flow path (401) can be provided and wherein said bottom section comprises a second-component outlet (43) near the bottom of the bottom section; and
wherein said output section (5) comprises a first-component outlet (51) and which is in direct fluid connection with and located above the top section. The inclinations of the inclined surface are with respect to a gravitational pull. The output section is preferably adapted to provide a counter-gravitational laminar flow path (501) at an angle α3. with respect to the gravitational pull.

Preferably, the top inclined rise surface (31) and the top inclined descend surface (32) are both inclined under an angle α1 such that the surfaces are essentially parallel. Similarly, preferably the bottom inclined rise surface (41) and the bottom inclined descend surface (42) are both inclined under an angle α2, such that the surfaces are essentially parallel. Angles α1 and α2 are accordingly inclined with respect to a gravitational pull. Preferably angle α3 is less inclined than α1 and α2.

‘Fluid connection’ is herein used for sections and sub-sections that are connected at least in a manner that allows for fluids to travel from one (sub-) section to another. ‘Direct fluid connection’ is herein used for sections and sub-section that are directly adjacent to one another and thus directly in a fluid connection with each other without said fluid having to pass through another section.

By providing the inclined rise and descend surfaces (31, 32, 41, 42), a short separation distance in the separator, expressed as the vertical distance D between the rise and descend surfaces, is provided. The steeper the inclination (i.e. the larger α1 and/or α2), the shorter the separation distance becomes. This advantageously leads to less collisions between the first and second components during separation and to a separation speed increase because of the group effect.

The invention can further be understood by considering a method in which the density-based separation can be used for separating the first and second components comprised in the feed fluid. It may be appreciated that the first and/or second components are, at least at the temperature at which the separation occurs, typically immiscible with each other and with the fluid. More particularly, the first and/or second components are typically solids and essentially insoluble in the fluid, at least at the temperature at which the separation occurs. Accordingly, as the first and/or second components may be immiscible or essentially insoluble in the fluid, the components may be separated due to gravitational force based on their relative densities. A schematic illustration of the separation of a first and a second component is presented in FIG. 8. In FIG. 8, the black filled circles represent the first component and the white unfilled circles (with black outlines) represent the second component.

As illustrated in FIG. 8, said method comprises providing a feed fluid to the feed fluid inlet (21) at a fluid inlet rate and leading said feed fluid into the middle section (2) wherein at least part of the first component contacts the top inclined rise surface (31) and/or the bottom inclined rise surface (41) such that a first-component enriched rising stream is formed and guided to the output section (5). It may be preferred that the top inclined rise surface at least partially extends downwards into the middle section and/or that the bottom inclined rise surface at least partially extends upwards into the middle section, such that the top and the bottom inclined rise surfaces are directly connected. Similarly, at least part of the second component contacts the top inclined descend surface (32) and/or the bottom inclined descend surface (42) such that a second-component enriched descending stream is formed and guided to the second-component outlet (43). It may be preferred that the top inclined descend surface at least partially extends downwards into the middle section and/or that the bottom inclined descend surface at least partially extends upwards into the middle section, such that the top and the bottom inclined descend surfaces are directly connected. The method further comprises leading the first-component enriched rising stream out of the first-component outlet (51) to obtain a first-component rich fraction and/or leading said second-component enriched descending stream out of said second component outlet (43) to obtain a second-component rich fraction.

The feed fluid is provided through the feed fluid inlet (21) into the separator at a fluid inlet rate. The position of the feed fluid inlet (21) can vary. For instance, the feed fluid inlet may be placed higher or lower, as long as there is a bottom inclined rise and bottom inclined descend surface below the feed fluid inlet. Further, the feed fluid inlet may be located such that the feed fluid enters the separator essentially parallel to the surface plane of the top and bottom inclined surfaces. The entrance may however also be essentially perpendicular to said surfaces. It may be appreciated that relative positions or locations of sections, surfaces and the like are herein described. As can be seen in FIG. 4, the middle section (2) and the feed fluid inlet (21) may be adapted to during use provide turbulence flow path (201). The turbulence flow path (201) is preferably essentially perpendicular to the gravitational pull. Accordingly, the fluid rate is preferably such that a middle turbulent flow (201) is provided in the middle section (2) as this may allow for the homogeneous distribution of the first and/or second component and may break up any agglomerates of the first and/or second component that are potentially present in the feed fluid. The turbulent flow path (201) may also be advantageous as this generally allows for an essentially homogeneous distribution of the first and second component over the middle section. Whether a turbulent flow path is preferred may be dependent on i.a. the dilution of the feed fluid. For instance, if the feed fluid is very diluted, the first and second components are typically already quite well distributed within the fluid. On the other hand, if the feed fluid is highly concentrated, turbulent flow may be preferred to allow for good distribution of the first and/or second component.

After the feed fluid has entered the separator, the first component tends to rise to the top surface of the fluid and the second component tends to descend to the bottom of the fluid due to the difference in densities between the components. The ability of the separator to be suitable for at least partially separating the first and second component is a fairly unique property as conventional separators typically only allow for the separation of rising components or descending components and not both simultaneously and individually. The difficulty in separating more than one component, especially one rising and one descending component in a fluid is that there is interaction between the first and second components. It may be appreciated that the separator is suitable for any two components that meet the density requirement, such as for instance ice and salt in a fluid mainly comprising water or air bubbles and sand in a fluid comprising oil.

Typically the rising first component can hinder the descending second component by e.g. physically blocking the second component or by providing an upwards force and vice versa. To minimize this hindrance the distance between the first and second component is preferably as large as possible, while the distance (D) between the top inclined rising surface and bottom inclined descending surface is preferably as small as possible. Distance (D) can be considered the length of an imaginary vertically straight line that can be drawn from the bottom inclined descending surface to the top inclined rising surface parallel to the gravitational pull. The shorter the distance D, the less collisions between the first and second component typically occur and the faster the separation of the components may be.

In particular embodiments, the top, middle and/or bottom sections are tubular, or their cross-sectional shapes perpendicular to the flow path are elongated (e.g. oval, with optional straight edges), rectangular or otherwise quadrilateral. The vertices of the cross-sectional shapes may be rounded-off. Tubular shapes are typically preferred as they tend to allow for efficient use of space and a homogeneous distribution of the fluid flow through the separator. Said elongated cross-sectional shapes may be preferred for up-scaling. It is more particularly preferred that the separation chamber is tubular or quadrilateral. In general, but particularly for the quadrilateral shapes or said other elongated cross-sectional shapes it is typically crucial that the feed fluid inlet (21) is adapted such that during use the fluid enters the separator over essentially the whole width of the separator or at least over essentially the whole width of the middle section (2). Width herein is used to indicate the longest dimension of the cross-sectional shape. For instance, in order to provide the fluid over the width of the separator, the feed fluid inlet may have a quadrilateral shape, such as a rectangular shape. The feed fluid inlet may further be connected to one or more pipes through which the fluid flows to the feed fluid inlet. Using one or more pipes may be beneficial as this may allow for an even distribution of the fluid and for easier integration of the separator in, for instance a water purification, system (vide infra)).

To minimize distance D several options may be feasible. A first option, for a preferred tubular separation chamber, is to decrease the diameter of the separation chamber. Similarly, for a preferred quadrilateral shape, one or more edges may be shortened. While this allows for the decrease of distance D, there may be challenges such as clogging of the separator and in particular clogging of the separation chamber due to limited available internal volume for the feed fluid. Clogging should be avoided as much as possible.

Alternatively or additionally, the top section and/or bottom section may comprise lamella (33, 45) and/or one or more tubes (34) to provide at least in part the inclined surfaces (31, 32, 41, 42). This is illustrated in FIG. 2 for lamella. In FIG. 2 it is further illustrated how distance D is reduced by the lamella as the inclined rise surfaces are significantly closer to the inclined descend surfaces due to the one or more lamella optionally present. FIG. 3A illustrates how the individual lamella (33) that may be present in the top section may comprise a top inclined rise surface (31) and a top inclined descend surface (32).

Alternatively or additionally, tubes (34) may be used in the top and/or bottom section. FIG. 3B illustrates a cross-sectional view of such tubes in the top section. Herein, it is further shown that each tube may individually comprise a top inclined rise surface (31) and a top inclined descend surface (32). Further, the tubes may have any shape, but due to packing efficiency as well as ease of distribution of the feed fluid over the pipes, hexagonal shapes (e.g. a honeycomb structure) are preferred. By inserting lamella and/or tubes not only distance D is reduced, but there is accordingly also more inclined surface available that may allow for the efficient separation of the components.

Alternatively or additionally, the inclination may be amended to reduce distance D. For instance, the top inclined rise surface, the top inclined descend surface, the bottom inclined rise surface and/or the bottom inclined descend surface may independently be inclined at least 5°, preferably between 10° and 80°, more preferably between 30° and 70°, most preferably between 40° and 60° with respect to the gravitational pull. In particular, for essentially parallel rise and descend surfaces, α1 and/or α2 may be adjusted to provide a larger inclination with respect to the gravitational pull. Accordingly, angles α1 and α2 are preferably independently at least 5°, preferably between 10° and 80°, more preferably wherein a is between 30° and 70°, most preferably wherein a is between 40° and 60°. FIG. 6 and FIG. 7 illustrate possible embodiments wherein the angles are adjusted. FIG. 6 illustrates a situation wherein α1 is larger than α2. FIG. 7 illustrates a situation wherein α1 varies over the separator and a curvature may be formed in the top section. The inclination may be beneficially chosen as large as possible to allow for a short distance D but not too large as to limit any accumulation of the first and/or second component.

Accordingly, by optimizing the angles and dimensions of the separator the separation of the components may be highly efficient. Another variable that may be taken into account to determine the optimal length of the bottom and/or top sections is the relative velocity of the first and/or second component through the liquid. The velocity is a factor that may determine the settling time and accordingly the time it takes for good separation.

For instance, the first component rising may have a higher velocity through the liquid than the second component descending. Therefore, the velocity of the second component descending is one of the determining factors for the dimensions of the separator. The flow in the top section may for instance be minimized to the point where this typically allows the first component to rise at a similar velocity as the descending velocity of the second component.

At least part of the first component contacts the top inclined rise surface (31) and/or the bottom inclined rise surface (41). Typically a plurality of particles of the first component are present in the feed fluid. As the first component tends to rise the majority of the particles may rise to the top inclined rise surface (31). However, some of the first component may be encapsulated and/or entrapped by the second component or may move downwards to reach the bottom inclined rise surface. Alternatively, some of the first component may also contact the inclined descend surfaces, however this will likely be minimal and the first component may be freed from the descend surfaces and flow to the inclined rise surfaces due to e.g. a fluid flow and/or gravitational force. At the inclined rise surfaces a first-component enriched rising stream is typically formed and guided to the output section (5).

Due to the enrichment of the stream a group effect typically occurs, the term group effect is used herein to describe the phenomena that a group of particles can move faster than the individual particles. Using lamella and/or tubes is particularly beneficial for obtaining this group effect as there is more surface area as well as a reduced distance D.

Similarly, at least part of the second component contacts the top inclined descend surface (32) and/or the bottom inclined descend surface (42) such that a second-component enriched descending stream is formed and guided to the second-component outlet (43). The group effect may also occur for the second component. It is also possible that some of the second component is encapsulated and/or trapped by the first component such that some of the second component flows to the rise surfaces. However, due to the flow regime within the separator, this is typically limited.

The flow regime in the separator at least entails that in between the top inclined descend surface (32) and the top inclined rise surface (31) a counter-gravitational laminar flow path (301) can be provided during use. Similarly, during use in between the bottom inclined descend surface (42) and the bottom inclined rise surface (41) a gravitational laminar flow path (401) can be provided. This is also illustrated in FIG. 1. The laminar flow paths (301, 401) are required during use as laminar flow allows for the separation of the first and second component. If the flow were turbulent, separation would typically not occur. Accordingly, the dimensions of the separator are chosen as such that laminar flow paths (301, 401) can be provided during use. Whether a laminar flow or a turbulent flow path is obtained, may for instance depend on the feed fluid inlet rate. The top section and/or bottom section may have a residue turbulent flow from for instance the middle section. This is not detrimental as long as there is a part in the top and/or bottom section that has a laminar flow path. Further, the length of the top and/or bottom section may also determine the residence time, a longer section results in an increase in residence time and thus an increase in time for separation to occur. However, a balance between length and residence time is typically preferred.

A preferred embodiment of the separator to further optimize the separation of the first and second component is illustrated in FIG. 9. In this preferred embodiment the separation chamber comprises a first section divider (80), typically in the form of a plate, that partially separates the top section (3) into two sub-sections: a second top sub-section (030) and a first top sub-section (031). The first top sub-section (031) comprises the top inclined rise surface (31) and the top inclined descend surface (32) while the a second top sub-section (030) comprises a second top inclined rise surface (312) and a second top inclined descend surface (322) . . . . The first section divider further partially separates the bottom section (4) into a second bottom sub-section (040) comprising a second bottom inclined descend surface (422) and a second bottom inclined rise surface (412) and a first bottom sub-section (041) comprising the bottom inclined rise surface (41) and the bottom inclined descend surface (42). The middle section (2) is herein in direct fluid connection with the first top sub-section (031) and the first bottom sub-section (041).

As illustrated in FIG. 9, the top inclined rise surface (31) and the bottom inclined rise surface (41) are provided on at least part of one of the planar sides of the first section divider while on it opposite planar side the second top sub-section (030) and the second bottom inclined descend surface (422) are provided. As such, advantageously, the first section divider physically divides streams in the separation chamber which results in less disturbance and mixing of the components to achieve a better separation. In other words, during use, in the first top sub-section (031), the rising stream of the first component along the top inclined rise surface (31) is physically shielded from the descending stream of the second component that descends along the second top (322).

Further, in the preferred embodiment as illustrated in FIG. 9, the separation chamber comprises a first kink at angle α11. Herein a kink in the separation chamber is defined as a point at which during use, the flow directions of the rising and descending streams horizontally flip at angle α11. Thus, by providing the kink, the top section (3) of the chamber comprises a further top inclined rise surface (311) and a further top inclined descend surface (321) which are preferably essentially parallel to each other but which guide the rising and descending streams in a direction that is horizontally opposite (i.e. horizontally flipped) to the direction of the top inclined rise surface (31) and the second tope inclined descend surface (322) respectively. Thus, the second top inclined rise surface (312) and the top inclined descend surface (32) end essentially at the first kink and moving upwards from the kink, the further top inclined rise surface (311) and the top inclined descend surface (321) are provided to continue to guide the rising and descending streams respectively. The first section divider preferably extends into or beyond the first kink in the top section, as illustrated in FIG. 9, such that rising stream that is guided by the top included surface (31) is guided into the top section (3) without it contacting the second top inclined rise surface (312) and such that the descending stream that is guided by the further top inclined descend surface (321) is guided from the top section (3) into the second top sub-section (030) onto the second top inclined descend surface (322).

The combination of the kink in the separation chamber and the first section divider advantageously allow the rising stream to be momentarily unguided by a rising surface followed by a collision with the further top inclined rise surface. In other words, the rising stream can essentially freely move in the separator, at least for some time, and is then caught by a next rising surface. Although the rising surfaces aim to gently guide the rising stream to the top of the separation chamber, i.a. to avoid inclusion of the second component in the first component, it was found to be preferable to occasionally shake-up the rising stream to loosen some included second component. This can thus be achieved by the combination of the kink in the separation chamber and the first section divider.

The principle of the combination of the kink in the separation chamber and the first section divider as illustrated in FIG. 9 can be extended to further kinks and section dividers. A particular embodiment thereof is illustrated in FIG. 10.

FIG. 10 illustrates another preferred embodiment wherein the separation chamber further comprises a second section divider (81), besides the first section divider (80). The second section divider (81) further divides the bottom section to provide a third bottom sub-section (042).

In the embodiment illustrated in FIG. 10, the first section divider (80) partially separates the top section (3) into two sub-sections: a second top sub-section (030) and a first top sub-section (031). The first top sub-section (031) comprises the top inclined rise surface (31) and the top inclined descend surface (32) while the second top sub-section (030) comprises a second top inclined rise surface (312) and a second top inclined descend surface (322). The first section divider extends into the bottom section to partially separate the bottom section (4) into a second bottom sub-section (040) comprising two second bottom inclined descend surfaces (421, 422) and two second bottom inclined rise surfaces (411, 412) and a first bottom sub-section (041) comprising the two bottom inclined rise surfaces (414, 413) and the second bottom inclined descend surface (42).

The first section divider preferably extends into or beyond the first kink in the top section, as illustrated in FIG. 10, such that rising stream that is guided by the top included surface (31) is guided into the top section (3) without it contacting the second top inclined rise surface (312) and such that the descending stream that is guided by the further top inclined descend surface (321) is guided from the top section (3) into the second sub-section (030) onto the second top inclined descend surface (322).

In the embodiment illustrated in FIG. 10, the second section divider at least partially divides the first bottom sub-section (041) from the third bottom sub-section (043). The third bottom sub-section typically comprises the third bottom inclined descend surface (423) and the bottom inclined rise surface (41).

The separation chamber of the embodiment illustrated in FIG. 10 comprises a second kink at angle α12. The rise surfaces 31 and 312 and the descend surfaces 32 and 322 start upwards from the second kink, while the rise surfaces 41, 412 and 413 and the descend surfaces 42, 422 and 423 end near the second kink.

The second section divider preferably extends into or beyond the second kink in the top section, as illustrated in FIG. 10, such that rising stream that is guided by the bottom inclined surface (413) is guided into the first top sub-section (031) without it contacting the bottom inclined rise surface (41) and such that the descending stream that is guided by the top inclined descend surface (32) is guided from the first top sub-section (031) into the third bottom sub-section (043) onto the third top inclined descend surface (423).

FIG. 10 further illustrates that the separator may comprise housing (1001) and means to fixate and/or stabilize the separator during use and/or storage, such as hooks (1000).

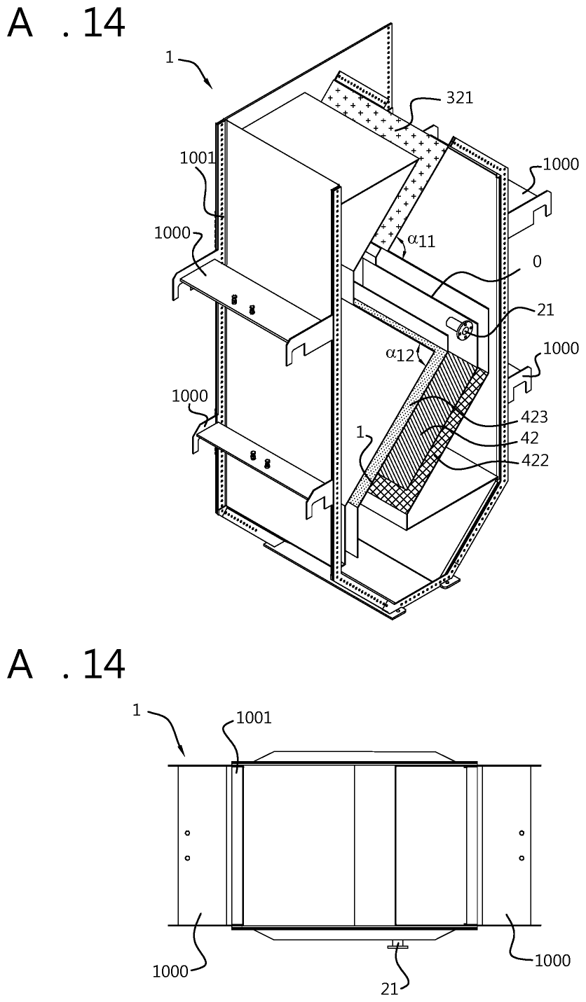

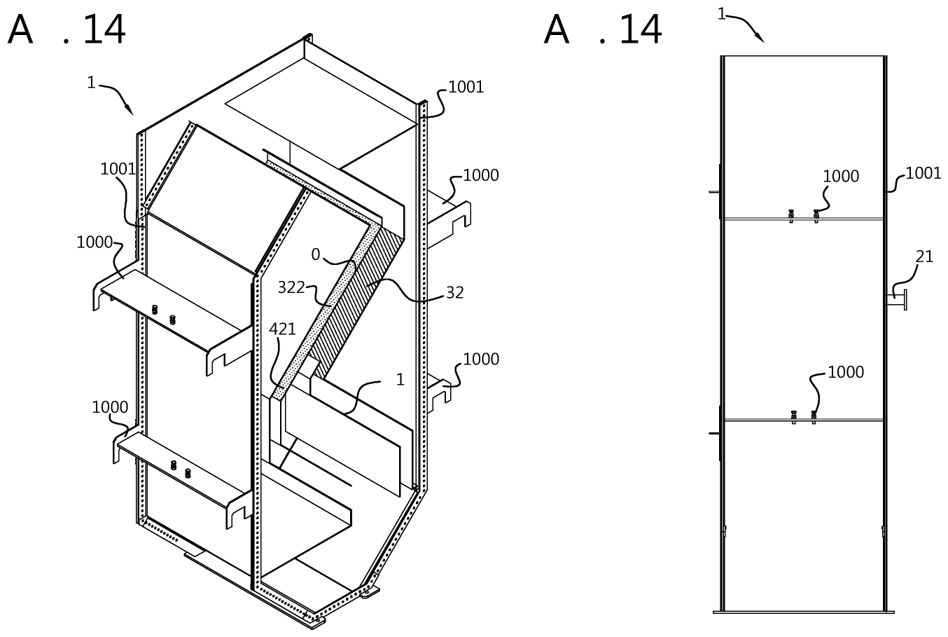

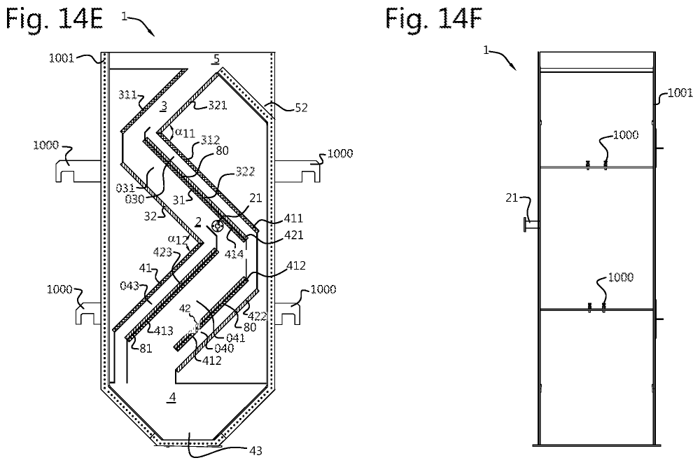

FIGS. 11-14 illustrate the preferred embodiment as illustrated in FIG. 10 and detailed above from several perspectives. FIG. 11 illustrates the preferred embodiment from a lower front view, FIG. 12 from a front side view, FIG. 13 from a front side view including additional housing. FIG. 14 illustrates a combination of views, A illustrates the separator from a front side view, B illustrates the top view, C illustrates the back side view, D illustrates a side view, E illustrates the front view and F illustrates another side view.

FIGS. 14A, D and F in particular further illustrate that the feed fluid inlet (21) may be located such that it is essentially parallel to the surface plane of the rise and descend surfaces as well as the one or more section dividers. In other words, the feed fluid inlet may be placed such that the fed fluid enters the separator in a direction from the front to the back of the separator.

These preferred embodiments and thus more generally a separator with at least one kink and at least one section divider typically allow for the rising stream to be unguided, or in other words essentially freely moving in the separator, at least for some time. This is generally considered advantageous as it may allow for more of the second component to fall out of the rising stream.

Additionally, after being unguided the rising stream may hit an inclined rise surface which typically provides additional energy for the second component to be released from the rising stream. The second component may then be allowed to contact a descend surface and be guided to the second component outlet.

Another advantage of such a configuration is that the required ground surface for placing the separator is limited.

The one or more section divider may further advantageously allow for the descending stream to be at least partially physically separated from the rising stream. This typically results in less disturbance and mixing of the components which results in a more efficient separation.

It may be appreciated that a plurality of further top and/or bottom inclined rise and/or descend surfaces at a plurality of kinks as well as section dividers that extend beyond the corresponding kink (e.g. the first section divider extends beyond the first kink, the second section divider extends beyond the second kink etc.) can be used consecutively in the separator to allow for maximal separation.

During use, the first-component enriched stream is guided to the output section (5). The vertical length of the output section (5) may be advantageously adjusted. In principle the length of the output section is preferably as long as possible as this allows for a concentrated first component portion to accumulate at the top. However, typically the length should not be too large for manufacturing purposes and bulkiness of the separator. A higher concentration may be beneficial for the further processing to obtain the first component. The residence time (i.e. the time the feed fluid is in the separator) may further be elongated to allow for concentrating the first component, an increased residence time can be achieved by i.a. lower feed fluid inlet rate or adjusting the dimensions of the separator. Further, angle α3 is preferably less inclined than the inclination of the inclined surfaces. In particular, α3 is preferably less inclined than α1 and α2 as a more vertical output section can be beneficial as an even compaction of the first component may take place.

The first-component enriched rising stream is led out of the first-component outlet to provide a first-component rich fraction. This may for instance be due to overflowing of the first component or is may be actively led out of the first-component, preferably by a fluid actuation device (7). Accordingly, it is preferred that the separator comprises a fluid actuation device (7) in the output section (5), as illustrated in FIG. 5. The fluid actuation device (7) may for instance be a mechanical stirrer and/or screw to during use force the first-component enriched stream out of the first-component outlet (51). The first-component rich fraction may be led to a filtering apparatus such as a centrifuge to obtain the first component.

Similarly, the second-component enriched descending stream can be led out of the second component outlet (43) to provide a second component rich fraction. The extraction may be active, by using for instance a pump. The second-component rich fraction may be led to a filtering apparatus to obtain the second component. It may be appreciated that any other means may also suffice to obtain the first and/or second component from a rich fraction.

The first-component rich fraction and/or the second-component rich fractions are typically a slurry. This as there is often a majority of solids in the fraction (i.e. the first and/or second component) and the fluid is typically separated.

The fluid remaining after the at least partial separation of the first and second component is herein referred to as the mother liquor. This mother liquor may be led through a mother liquor outlet (44) to provide a mother liquor stream. This stream can be recycled, preferably by feeding the stream to a mother liquor inlet (52) and/or by feeding the mother liquor stream to the feed fluid inlet (21). It is accordingly preferred that the method is a continuous method.

This is further seen in FIG. 4, where a preferred embodiment of the density-based separator is illustrated and further comprises a mother liquor inlet (52) in the output section (5) located near the bottom of the output section. Near herein is used to describe that the mother liquor inlet is typically located such that there is sufficient room for the first component to concentrate above the mother liquor inlet (52) and overflow into the first component outlet (51). This mother liquor inlet is preferably adapted to during use provide a turbulent flow (502) in at least part of the output section. The turbulent flow (502) may be beneficially used to wash the first component that has risen to the output section. Laminar flow may however also be sufficient to function as a washing means for the first component. Laminar flow may also allow for minimal disturbance of the rising first component. The mother liquor inlet may advantageously be used for feeding a mother liquor stream into the separator which can be used to lower, stop and/or reverse the flow rate in the top section.

It may further be preferred that the bottom section (4) further comprises a mother liquor outlet (44) placed above the second-component outlet (43) as illustrated in FIG. 4 and FIG. 5. This outlet is preferably adapted to during use provide a laminar flow as this typically prevents the second component to exit the separator through the mother liquor outlet. The mother liquor outlet (44) is preferably connected to the mother liquor inlet (52), to provide the recycling stream. This may for instance be beneficial if some of the second component exits through the mother liquor outlet, as in this way it is recycled back into the separator and may be further separated.

Additionally or alternatively, the feed fluid inlet (21) may comprise a mother liquor feed inlet (22) as can be seen in FIG. 5, wherein the mother liquor outlet (44) is connected to said mother liquor feed inlet (22). The mother liquor that may be fed through the mother liquor feed inlet (22) can for instance be used to dilute the feed fluid. This dilution can for instance be beneficial for breaking up any agglomerates of the first and/or second component. Or some second component may be present in the mother liquor stream and recycling this stream back into the separator may further separate the second component from the fluid.

FIG. 5 further illustrates that the separator may comprise a flow disturbance minimizer (6) in the middle section (2). A flow disturbance minimizer can be used to minimize the disturbance of the laminar flow paths (301, 401) and may accordingly allow for an unhindered or less hindered progression of the separation. The disturbance minimizer may also advantageously be used to minimize any disturbance of components that are e.g. contacted or settled on the inclined descend surfaces. It may be increasingly favorable for the separator to comprise a flow disturbance minimizer for an increasing capacity of the separator. The flow disturbance minimizer may aid in homogeneously distributing the feed fluid over the width of the separator. Dependent on the fluid inlet rate and the capacity of the separator, the dimensions of the flow disturbance minimizer may be amended. While the optional flow disturbance minimizer is located in the middle section, the flow disturbance minimizer may extend into the top (3) and/or bottom section (4). This flow disturbance minimizer may for instance comprise a plate that is placed in said middle section with its surface plane essentially facing to the feed fluid inlet under an angle and with its surface plane essentially parallel to the top inclined descend surface. A plate having its surface plane facing the fluid inlet, can reduce flow disturbance of the descending stream that may be created by the stream of feed fluid coming through the feed fluid inlet (21) by providing a physical barrier between the inlet stream and the descending stream that is flowing at the other side of the plate. By placing the plate such that its surface plane is essentially parallel to the top inclined descend surface, the descending stream is not substantially hindered. However, any other angle of the surface plane may also be feasible, as long as the descending and/or rising second and/or first components are not disturbed.

The disturbance may further or alternatively be minimized by methods such as adjusting the inlet of the feed fluid. This may for instance be achieved by using a fluid inlet that comprises an inlet tube that is connected to the middle section perpendicular to a plane of the inclined descend surface that is extending into the middle section. It is further preferred that the inlet tube is connected to the middle section at an angle ß with respect to said plane of the inclined descend surface as illustrated in FIG. 5, wherein ß is preferably less than 90°, preferably less than 70°. By adjusting the angle ß the disturbance of the laminar flow paths in the top and/or bottom section may be reduced.

In a preferred embodiment, the first component is ice and the second component is a salt, preferably wherein the fluid is water. Both ice and salt are typically present as a crystal in their solid form. Accordingly, the ice does typically not melt and remains immiscible with the water. Additionally, the salt crystals do not tend to solubilize in the water. The crystal size distribution of the ice and/or the salt and the concentration and/or density thereof in the feed fluid typically determines the average distance between the crystals. This average distance in turn may determine the amount of interaction between the crystals and thus may have an impact on the separation and possible agglomeration. In particular, ice tends to agglomerate in loose structures that may encapsulate salt particles. This encapsulation for instance occurs when the ice concentration and/or density in the feed fluid is above a certain threshold called the critical point. It is therefore preferred that most or all the separation has occurred before this critical point is reached. The time associated with reaching the critical point may be dependent on the difference in velocity of the ice and the salt through the fluid, more particularly the velocity of the rising ice is typically paramount for the time it takes to reach the critical point. A smaller difference in velocity may be favorable for a good separation under the same conditions.

The density-based separator may be used in a water purification system. In particular it is preferred that the separator is used in a eutectic freeze crystallization (EFC) water purification system. A eutectic freeze crystallization water purification system may for instance further comprise a EFC crystallizer wherein e.g. ice and salt is formed and fed to the separator through the feed fluid inlet. The residence time in such a EFC crystallizer may determine i.a. the crystal size distribution and concentration and/or density of the first and/or second component in the feed fluid.

For the purpose of clarity and a concise description features are described herein as part of the same or separate embodiments, however, it will be appreciated that the scope of the invention may include embodiments having combinations of all or some of the features described.

The invention may further be illustrated by the following non-limiting examples.

### EXAMPLE 1

A tubular density-based separator illustrated in FIG. 4 was made with the following parameters. A feed fluid was used comprising ice and salt.
Distance D—ca. 14 cm
Length top section—ca. 80 cm
Length bottom section—ca. 120 cm
Total volume of the separation chamber—ca. 15.7 liters
Diameter of separation chamber—ca. 10 cm
Angles α1 and α2—ca. 45°

These dimensions were such that 1 liter of feed fluid was contained in approximately 12 cm length of the separator. A feed fluid inlet rate of 1 l/min equals a velocity of approximately 7.6 m/h.

The velocity of the ice rising was measured at about 24 m/h, where the velocity of the salt descending was measured at about 4.5 m/h.

1. A density-based separator for at least partially separating a first and a second component comprised in a feed fluid, wherein said first component has a lower density than said fluid and said second component has a higher density than said fluid, wherein said separator comprises an output section and a separation chamber that comprises a top section, a middle section and a bottom section which are all in direct fluid connection with each other, wherein said top section is located above the middle section and said bottom section is located below said middle section; wherein:
a) said middle section comprises a feed fluid inlet;
b) said top section comprises a top inclined rise surface that is adapted to, during use of the separator, guide a rising stream that is enriched in the first component to the output section and a top inclined descend surface that is adapted to, during use of the separator, guide a descending stream that is enriched in the second component to the middle section, the bottom section, or the middle section and the bottom section, and wherein, in between which surfaces, during use of the separator, a counter-gravitational laminar flow path can be provided; and
c) said bottom section comprises a bottom inclined rise surface that is adapted to, during use of the separator, guide a rising stream that is enriched in the first component to the top section and a bottom inclined descend surface that is adapted to, during use of the separator, guide a descending stream that is enriched in the second component downwards, and wherein, in between which surfaces during use, a gravitational laminar flow path can be provided, and wherein said bottom section comprises a second-component outlet near the bottom of the bottom section;
wherein said output section comprises a first-component outlet and which is in direct fluid connection with and located above the top section; and
wherein the top inclined rise surface, top inclined descend surface, bottom inclined rise surface, and bottom inclined descend surface are inclined with respect to a gravitational pull.

2. The density based-separator of claim 1, wherein said output section is adapted to provide a counter-gravitational laminar flow path at an angle α3 with respect to the gravitational pull.

3. The density-based separator of claim 1, wherein the top section, middle section, bottom section, or any combination of the top section, middle section, and bottom section is tubular or quadrilateral.

4. The density-based separator of claim 1, wherein the top section, the bottom section, or the top section and the bottom section comprise lamella, one or more tubes, or lamella and one or more tubes to provide at least in part the top inclined rise surface, top inclined descend surface, bottom inclined rise surface, and bottom inclined descend surface.

5. The density-based separator of claim 1, wherein said output section further comprises a mother liquor inlet located near the bottom of the output section.

6. The density-based separator of claim 1, wherein said bottom section further comprises a mother liquor outlet placed above the second-component outlet.

7. The density-based separator of claim 6, wherein said output section further comprises a mother liquor inlet located near the bottom of the output section and wherein the mother liquor outlet is connected to the mother liquor inlet.

8. The density-based separator of claim 6, wherein the feed fluid inlet comprises a mother liquor feed inlet and wherein the mother liquor outlet is connected to said mother liquor feed inlet.

9. The density-based separator of claim 1, wherein said feed fluid inlet and middle section are adapted to, during use, provide turbulence flow path.

10. The density-based separator of claim 9, wherein said turbulence flow path is essentially perpendicular to said gravitational pull.

11. The density-based separator of claim 1, wherein the top inclined rise surface, bottom inclined rise surface, top inclined descend surface, and bottom inclined descend surface are independently inclined at least 5° with respect to the gravitational pull.

12. The density-based separator of claim 1, wherein the top inclined descend surface at least partially extends downwards into the middle section, wherein the bottom inclined descend surface at least partially extends upwards into the middle section, or wherein the top inclined descend surface at least partially extends downwards into the middle section and the bottom inclined descend surface at least partially extends upwards into the middle section, such that the top inclined descend surface and the bottom inclined descend surface are directly connected.

13. The density-based separator of claim 1, wherein the top inclined rise surface at least partially extends downwards into the middle section, wherein the bottom inclined rise surface at least partially extends upwards into the middle section, or wherein the top inclined rise surface at least partially extends downwards into the middle section and the bottom inclined rise surface at least partially extends upwards into the middle section, such that the top inclined rise surface and the bottom inclined rise surface are directly connected.

14. The density-based separator of claim 12, wherein said fluid inlet comprises an inlet tube that is connected to the middle section, wherein said inlet tube is connected to the middle section such that a plane of the inclined descend surface that is extending into the middle section is facing the inlet tube at an angle β that is less than 90° with respect to said plane of the inclined descend surface, a plane of the inclined rise surface that is extending into the middle section is facing the inlet tube at an angle β that is less than 90° with respect to said plane of the inclined rise surface, or a plane of the inclined descend surface that is extending into the middle section is facing the inlet tube at an angle β that is less than 90° with respect to said plane of the inclined descend surface and a plane of the inclined rise surface that is extending into the middle section is facing the inlet tube at an angle β that is less than 90° with respect to said plane of the inclined rise surface.

15. The density-based separator of claim 11, wherein the middle section comprises a flow disturbance minimizer.

16. The density-based separator of claim 1, further comprising a fluid actuation device.

17. The density-based separator of claim 1, wherein said separation chamber comprises a first section divider that partially separates the top section into a second top sub-section comprising a second top inclined rise surface and a second top inclined descend surface, and a first top sub-section comprising the top inclined rise surface and the top inclined descend surface;
wherein said first section divider further partially separates the bottom section into a second bottom sub-section comprising a second bottom inclined descend surface and a second bottom inclined rise surface and a first bottom sub-section comprising the bottom inclined rise surface and the bottom inclined descend surface;
wherein said middle section is in direct fluid connection with the first top sub-section and the first bottom sub-section; and
wherein said separation chamber comprises a kink at angle α11 and a further top inclined rise surface and a further top inclined descend surface located above said kink at angle α11.

18. The density-based separator of claim 1, wherein the separation chamber comprises a first section divider that partially separates the top section into a second top sub-section comprising a second top inclined rise surface and a second top inclined descend surface, and a first top sub-section comprising the top inclined rise surface and the top inclined descend surface;
wherein said first section divider further partially separates the bottom section into a second bottom sub-section comprising a first bottom inclined descend surface, a second bottom inclined descend surface, a first bottom inclined rise surface and a second bottom inclined rise surface,
and a first bottom sub-section comprising a third bottom inclined rise surface, a fourth bottom inclined rise surface, and the bottom inclined descend surface;
which separation chamber further comprises a second section divider that at least partially further separates the bottom section into in a third bottom sub-section which comprises a third bottom inclined descend surface and the bottom inclined rise surface;
and wherein said separation chamber comprises a kink at angle α12.

19. A method for at least partially separating a first component and a second component comprised in a feed fluid performed in a density-based separator of claim 1, wherein said method comprises providing a feed fluid to the feed fluid inlet at a fluid inlet rate;
wherein at least part of the first component contacts the top inclined rise surface, the bottom inclined rise surface, or the top inclined rise surface and the bottom inclined rise surface such that a first-component enriched rising stream is formed and guided to the output section;
wherein at least part of the second component contacts the top inclined descend surface, the bottom inclined descend surface, or the top inclined descend surface and the bottom inclined descend surface such that a second-component enriched descending stream is formed and guided to the second-component outlet;
wherein said method further comprises leading the first-component enriched rising stream out of the first-component outlet to obtain a first-component rich fraction, leading said second-component enriched descending stream out of said second component outlet to obtain a second-component rich fraction, or leading the first-component enriched rising stream out of the first-component outlet to obtain a first-component rich fraction and leading said second-component enriched descending stream out of said second component outlet to obtain a second-component rich fraction.

20. The method of claim 19, wherein said fluid inlet rate is adapted to provide a turbulent flow in the middle section.

21. The method of claim 19, wherein said first-component rich fraction is a slurry, said second-component rich fraction is a slurry, or wherein said first-component rich fraction is a slurry and said second-component rich fraction is a slurry.

22. The method of claim 19, said method further comprises:
leading said first-component rich fraction to a filtering apparatus to obtain said first component;
leading said second-component rich fraction to a filtering apparatus to obtain said second component; or
leading said first-component rich fraction to a filtering apparatus to obtain said first component and leading said second-component rich fraction to a filtering apparatus to obtain said second component.

23. The method of claim 19, wherein said first component is ice and said second component is a salt.

24. The method of claim 19, wherein the first-component enriched stream is actively led out of the first-component outlet.

25. The method of claim 19, further comprising leading a mother liquor stream out of the mother liquor outlet.

26. The method of claim 25, wherein said method further comprises recycling said mother liquor stream.

27. The method of claim 19, wherein said method is a continuous method.

28. A water purification system comprising the separator of claim 1.
